(19) United States
(12) Patent Application Publication
(10) Pub. No.: US 2026/0071476 A1
(43) Pub. Date: Mar. 12, 2026

(54) Actuating Mechanism and Vehicle

(71) Applicant: Illinois Tool Works Inc., Glenview, IL (US)

(72) Inventor: Linjie Ji, Shanghai (CN)

(21) Appl. No.: 19/318,842

(22) Filed: Sep. 4, 2025

(30) Foreign Application Priority Data
Sep. 6, 2024 (CN) 202411253679.5
Aug. 29, 2025 (CN) 202511236460.9

(51) Int. Cl. E05F 15/611

(52) U.S. Cl. CPC E05F 15/611; E05Y 2201/216; E05Y 2201/608; E05Y 2201/702; E05Y 2201/704; E05Y 2900/534

(57) ABSTRACT

An actuating mechanism for driving a driven element to move. The actuating mechanism includes a driving element and a transmission device. The driving element provides a positive driving torque. The transmission device controllably connects the driving element and the driven element and includes a first clutch and a second clutch arranged in series. The first clutch is designed to be in an engaged state or in a disengaged state depending on whether a torque to be transmitted is less than or greater than a first torque threshold, and the second clutch is designed and arranged such that the second clutch is in an engaged state or a disengaged state depending on whether the torque to be transmitted is less than or greater than a second torque threshold when the driven member is subjected to a reverse driving torque in a first rotational direction, and that the second clutch remains in the engaged state when the driven element is subjected to a reverse driving torque in a second rotational direction. The second torque threshold is less than the first torque threshold.

### RELATED APPLICATIONS

The present application claims the benefit of Chinese Patent Application Nos. 202411253679.5, filed Sep. 6, 2024, and 202511236460.9, filed Aug. 29, 2025, each titled “Actuating Mechanism and Vehicle,” the contents of which are hereby incorporated by reference.

### TECHNICAL FIELD

The present disclosure relates to an actuating mechanism, in particular an actuating mechanism for a cover of a charging port or a fueling port of a vehicle, and a vehicle including the actuating mechanism.

### BACKGROUND

A vehicle is provided with a cover at a fueling port or charging port, and the cover is configured to open or close the fueling port or charging port of the vehicle. The cover has an open position and a closed position and is movable between the open position and the closed position. The cover is connected to an actuating mechanism that is capable of driving the cover to move between the open and closed positions.

### SUMMARY

The present disclosure relates to an actuating mechanism, substantially as illustrated by and described in connection with at least one of the figures, as set forth more completely in the claims. More particularly, the present disclosure relates generally to a fastening system having a removable clip.

### DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1A is a perspective view of an actuating mechanism according to an embodiment of the present disclosure.

FIG. 1B is an exploded view of the actuating mechanism shown in FIG. 1A.

FIG. 2A is a perspective view of a first clutch shown in FIG. 1B.

FIG. 2B is an exploded view of the first clutch shown in FIG. 2A.

FIG. 3A is a perspective view of a second clutch shown in FIG. 1B.

FIG. 3B is an exploded view of the second clutch shown in FIG. 3A.

FIG. 3C is a radial cross-sectional view of the second clutch shown in FIG. 3A.

FIG. 3D is an axial cross-sectional view of the second clutch shown in FIG. 3A.

FIG. 4A is a perspective view of a driving element and a transmission device shown in FIG. 1B in a first operating condition.

FIG. 4B is a perspective view of the driving element and the transmission device shown in FIG. 1B in a second operating condition.

FIG. 5 is a schematic diagram of a vehicle using the actuating mechanism shown in FIG. 1A.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein is not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent to or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y. ” As another example, “x, y, and/or z” means any element of the seven-element set {(x), (y), (z), (x, y), (x, z), (y, z), (x, y, z)}. In other words, “x, y, and/or z” means “one or more of x, y, and z.”

According to a first aspect of the present disclosure, the present disclosure provides an actuating mechanism for driving a driven element to move. The actuating mechanism includes a driving element and a transmission device. The driving element provides a positive driving torque. The transmission device controllably connects the driving element and the driven element and includes a first clutch and a second clutch arranged in series. The first clutch is designed to be in an engaged state or in a disengaged state depending on whether a torque to be transmitted is less than or greater than a first torque threshold, and the second clutch is designed and arranged such that the second clutch is in an engaged state or a disengaged state depending on whether the torque to be transmitted is less than or greater than a second torque threshold when the driven member is subjected to a reverse driving torque in a first rotational direction, and that the second clutch remains in the engaged state when the driven element is subjected to a reverse driving torque in a second rotational direction. The second torque threshold is less than the first torque threshold.

In some embodiments, when the driven element is subjected to the reverse driving torque in the first rotational direction, a holding torque provided by the actuating mechanism to the driven element is determined by the second torque threshold, and when the driven element is subjected to the reverse driving torque in the second rotational direction, the holding torque provided by the actuating mechanism to the driven element is determined by the first torque threshold.

In some embodiments, the first clutch is a friction clutch. The second clutch is a composite device incorporating an overrunning clutch function and a friction clutch function.

In some embodiments, the first clutch includes a first driving member, a first driven member and a friction plate. The friction plate connects the first driving member and the first driven member by friction to enable the first driving member and the first driven member to rotate relative to each other or not rotate relative to each other depending on the magnitude of the torque to be transmitted, thereby achieving the engaged state or the disengaged state of the first clutch.

In some embodiments, the second clutch includes a second driving member, a second driven member, an overrunning clutch coupling assembly and a friction clutch coupling element. The overrunning clutch coupling assembly is configured to clamp or release the second driving member and the second driven member against or from each other, and the friction clutch coupling element connects the second driving member and the second driven member by friction. The second clutch is designed such that: when the second driven member rotates relative to the second driving member in one rotational direction, the overrunning clutch coupling assembly clamps the second driven member and the second driving member against each other, thereby maintaining the second clutch in the engaged state in the one rotational direction; and when the second driven member rotates relative to the second driving member in the other rotational direction, the overrunning clutch coupling assembly releases the second driven member and the second driving member from each other, the engaged state or the disengaged state of the second driven member and the second driving member is controlled by the friction clutch coupling element, whereby the second driven member and the second driving member are enabled to rotate relative to each other or not rotate relative to each other depending on the magnitude of the torque to be transmitted, achieving the engaged state or the disengaged state of the second clutch in the other rotational direction.

In some embodiments, the overrunning clutch coupling assembly includes a rolling member and an elastic member, and a wedge-shaped space is formed between the second driven member and the second driving member for accommodating the rolling member and the elastic member. The wedge-shaped space narrows gradually in the radial direction and has a wider first end wall and a narrower second end wall, and the elastic member is positioned closer to the first end wall than the rolling member.

In some embodiments, the friction clutch coupling element is a torsion spring fixedly connected to the second driving member and is connected to the second driven member via an interference fit.

In some embodiments, the second driving member includes an outer ring and a support portion provided at one end of the outer ring. The second driven member includes a coupling portion and a connecting segment arranged axially. The coupling portion is accommodated in the outer ring and defines the wedge-shaped space together with the outer ring, the torsion spring is sleeved over the connecting segment, and one end of the torsion spring is connected to the support portion.

In some embodiments, the transmission device includes a worm connected to a shaft of the driving element, and a worm gear meshing with the worm. The worm and the worm gear are configured such that the worm is capable of transmitting the positive driving torque to the worm gear but the worm gear is not capable of transmitting the reverse driving torque to the worm.

In some embodiments, the transmission device further includes a first transmission gear and a second transmission gear, the first transmission gear is rotationally fixedly connected to the worm gear, the second transmission gear is rotationally fixedly connected to the driven element, and the first transmission gear, the first clutch, the second clutch and the second transmission gear mesh in sequence.

According to a second aspect of the present disclosure, the present disclosure provides an actuating mechanism for driving a driven element to move. The actuating mechanism includes a driving element and a transmission device. The driving element provides a positive driving torque. The transmission device controllably connects the driving element and the driven element and includes a first clutch and a second clutch arranged in series. The first clutch is a friction clutch. The second clutch is a composite device incorporating an overrunning clutch function and a friction clutch function.

In some embodiments, the second clutch includes a second driving member, a second driven member, an overrunning clutch coupling assembly and a friction clutch coupling element, the overrunning clutch coupling assembly is configured to clamp or release the second driving member and the second driven member against or from each other, and the friction clutch coupling element connects the second driving member and the second driven member by friction.

In some embodiments, the overrunning clutch coupling assembly includes a rolling member and an elastic member, and a wedge-shaped space is formed between the second driven member and the second driving member for accommodating the rolling member and the elastic member. The wedge-shaped space narrows gradually in the radial direction and has a wider first end wall and a narrower second end wall, the elastic member being positioned closer to the first end wall than the rolling member.

In some embodiments, the friction clutch coupling element is a torsion spring fixedly connected to the second driving member and is connected to the second driven member via an interference fit.

In some embodiments, the second driving member includes an outer ring and a support portion provided at one end of the outer ring. The second driven member includes a coupling portion and a connecting segment arranged axially. The coupling portion is accommodated in the outer ring and defines the wedge-shaped space together with the outer ring, the torsion spring is sleeved over the connecting segment, and one end of the torsion spring is connected to the support portion.

In some embodiments, the transmission device includes a worm connected to a shaft of the driving element, and a worm gear meshing with the worm. The worm and the worm gear are configured such that the worm is capable of transmitting the positive driving torque to the worm gear but the worm gear is not capable of transmitting the reverse driving torque to the worm.

In some embodiments, the transmission device further includes a first transmission gear and a second transmission gear, the first transmission gear is rotationally fixedly connected to the worm gear, the second transmission gear is rotationally fixedly connected to the driven element, and the first transmission gear, the first clutch, the second clutch and the second transmission gear mesh in sequence.

According to a third aspect of the present disclosure, the present disclosure provides a vehicle. The vehicle includes an actuating mechanism as aforementioned and a cover. The cover is the driven element and is used for a fueling port or a charging port of the vehicle, and the cover is configured to move in an opening direction from a closed position to an open position under the action of the positive driving torque provided by the driving element, or to move in a closing direction from the open position to the closed position.

In some embodiments, the vehicle further includes a sensor and a control device. The sensor is configured to detect that the second clutch is switched to a disengaged state. The control device is communicatively connected to the sensor. When the cover in the open position is subjected to the reverse driving torque in the first rotational direction, the cover has a tendency to be closed, the second clutch is switched to the disengaged state when the reverse driving torque in the first rotational direction is greater than the second torque threshold, and the control device controls the driving element to drive the cover to close in response to the second clutch switching to the disengaged state.

In some embodiments, when the cover in the closed position is subjected to the reverse driving torque in the second rotational direction, the cover has a tendency to be opened, and the holding torque applied by the actuating mechanism to the cover is determined by the first torque threshold of the first clutch to prevent the cover from being opened with a small force.

By incorporating the first clutch and the second clutch, the actuating mechanism of the present disclosure can provide different holding torques in the two rotational directions for the cover, where the holding torque is relatively small in the closing direction of the cover, and the holding torque is relatively large in the opening direction of the cover.

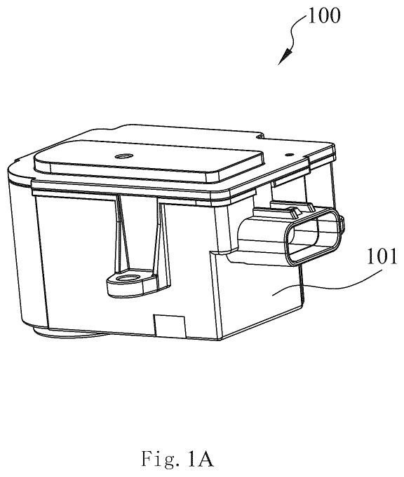

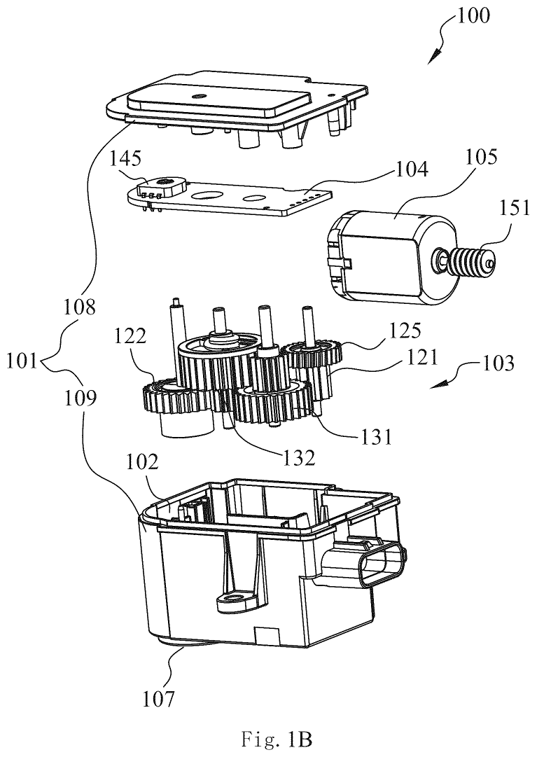

FIG. 1A is a perspective view of an actuating mechanism 100 according to an embodiment of the present disclosure, and FIG. 1B is an exploded view of the actuating mechanism 100. As shown in FIGS. 1A and 1B, the actuating mechanism 100 includes a housing 101, a driving element 105, a transmission device 103, and a circuit board 104. The housing 101 includes a housing body 109 and a cover 108. The housing body 109 has a top opening 102 and a bottom opening 107. The driving element 105, the transmission device 103 and the circuit board 104 are mounted into the housing body 109 via the top opening 102, and the cover 108 encloses the top opening 102. The transmission device 103 is connected to an external driven element (such as a cover of a charging port or a fueling port of a vehicle, see FIG. 5) via the bottom opening 107 so as to drive the driven element to move.

The transmission device 103 controllably connects the driving element 105 to the driven element. The transmission device 103 includes a worm 151 connected to a shaft of the driving element 105. The transmission device 103 further includes a worm gear 125, a first transmission gear 121, a first clutch 131, a second clutch 132 and a second transmission gear 122. The worm gear 125 is rotationally fixedly connected to the first transmission gear 121, and the second transmission gear 122 is rotationally fixedly connected to the driven element. The worm 151 meshes with the worm gear 125, and the first transmission gear 121, the first clutch 131, the second clutch 132 and the second transmission gear 122 mesh in sequence.

The transmission device 103 thereby establishes a connectable and disconnectable torque transmission path between the driving element 105 and the driven element. The first clutch 131 and the second clutch 132 are arranged in series in the torque transmission path. Each of the first clutch 131 and the second clutch 132 have an engaged state and a disengaged state. The first clutch 131/second clutch 132 can connect the torque transmission path when in the engaged state. The first clutch 131/second clutch 132 can disconnect the torque transmission path when in the disengaged state.

When the driving element 105 provides a positive driving torque, the transmission device 103 transmits the positive driving torque from the driving element 105 to the driven element. The driven element can be subjected to a reverse driving torque by external forces. The positive driving torque may include torque in two rotational directions (including clockwise and counterclockwise directions), and the reverse driving torque may also include torque in two rotational directions (including clockwise and counterclockwise directions).

In one application of an actuating mechanism of the present disclosure, the driven element is a cover for a fueling port or a charging port of a vehicle, and the actuating mechanism is configured to drive the cover of the fueling port or charging port of the vehicle to rotate between an open position and a closed position, and to hold the cover in the open position and the closed position. By providing the first clutch 131 and the second clutch 132, the actuating mechanism of the present disclosure may provide the cover with different holding torques in two rotational directions, where the holding torque is relatively small in a closing direction of the cover, and the holding torque is relatively large in an opening direction of the cover. As a result, the actuating mechanism of the present disclosure allow the cover in the open position to be easily pushed toward the closed position, and prevents the cover in the closed position from being inadvertently opened due to vibrations or other factors.

In some embodiments, the driving element 105 is an electric motor. The circuit board 104 is provided with a sensor 145 capable of detecting that the second clutch 132 is switched to the disengaged state.

In some embodiments, the worm gear 125 and the worm 151 form a self-locking device, the worm 151 is capable of transmitting the positive driving torque to the worm gear 125, but the worm gear 125 is not capable of transmitting the reverse driving torque to the worm 151.

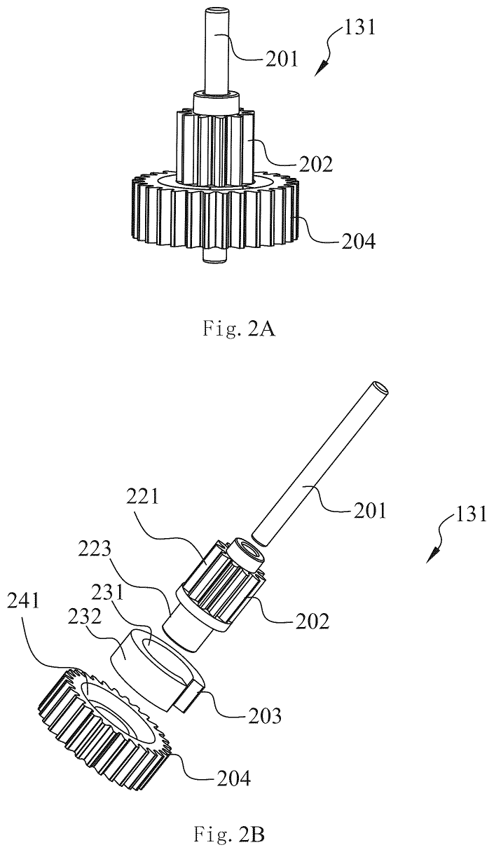

FIG. 2A is a perspective view of the first clutch 131, and FIG. 2B is an exploded view of the first clutch 131. In the embodiment shown, the first clutch 131 is a friction clutch which is designed to be in the engaged state or disengaged state depending on whether the torque to be transmitted is less than or greater than a first torque threshold. Therefore, the first friction clutch 131 is a torque operated clutch and is a bidirectional clutch.

As shown in FIGS. 2A and 2B, the first clutch 131 includes a first shaft 201, a first driving member 204, a friction plate 203 and a first driven member 202. The first shaft 201 rotatably connects the first driven member 202 to the housing. The friction plate 203 is arranged between the first driving member 202 and the first driven member 204 and is in interference fit with the first driving member 202 and the first driven member 204, thereby connecting the two by friction. The friction plate 203 is generally annular with a notch, and has an inner surface 231 and an outer surface 232.

The first driving member 204 is generally annular in shape and forms an outer gear. The first driving member 204 has a receiving cavity 241 within which the friction plate 203 is received, and the outer surface 232 of the friction plate 203 is in contact with an inner wall of the receiving cavity 241.

The first driven member 202 is generally cylindrical, and has a first driven member meshing portion 221 and a connecting segment 223 which are axially arranged. The first driven member meshing portion 221 forms an outer gear. The connecting segment 223 is inserted into the friction plate 203 and is in contact with the inner surface of the friction plate 203.

The first clutch 131 meshes with the first transmission gear 121 by the first driving member 204 such that the first driving member 204 rotates under the drive of the driving element 105, and meshes with the second clutch 132 by the first driven member 202. The cooperation of the friction plate 203 with the first driving member 204 and the second driven member 202 provides a first torque threshold for the first clutch 131, which is the maximum torque that can be transmitted by the first clutch 131. When the positive driving torque to be transmitted by the first driving member 204 or the reverse driving torque to be transmitted by the first driven member 202 is greater than the first torque threshold, the first driving member 204 and the first driven member 202 may rotate relative to each other, so that the first clutch 131 is in the disengaged state. When the positive driving torque to be transmitted by the first driving member 204 or the reverse driving torque to be transmitted by the first driven member 202 is less than the first torque threshold, the first driving member 204 and the first driven member 202 do not rotate relative to each other but rotate synchronously, so that the first clutch 131 is in the engaged state. The first clutch 131 in the engaged state is capable of transmitting torque, whereas the first clutch 131 in the disengaged state cannot transmit torque.

It will be appreciated by those skilled in the art that in other embodiments, the first clutch may also be a friction clutch composed of elements other than those illustrated, while still achieving the technical effects of engagement and disengagement as described above.

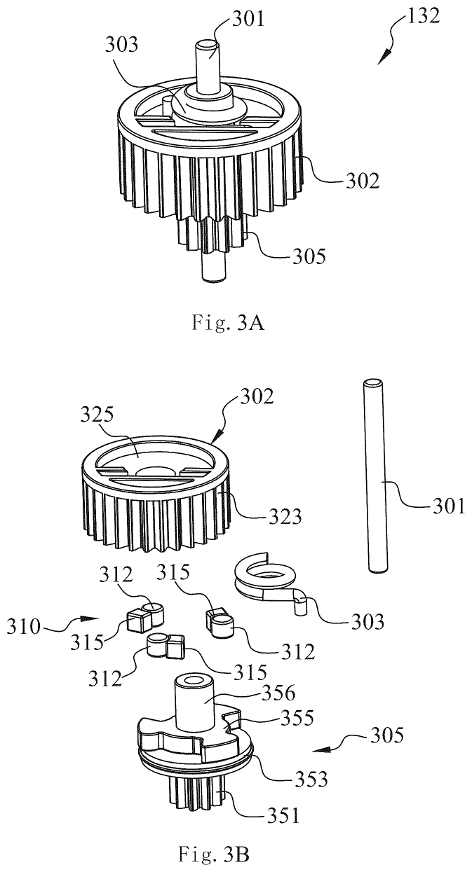

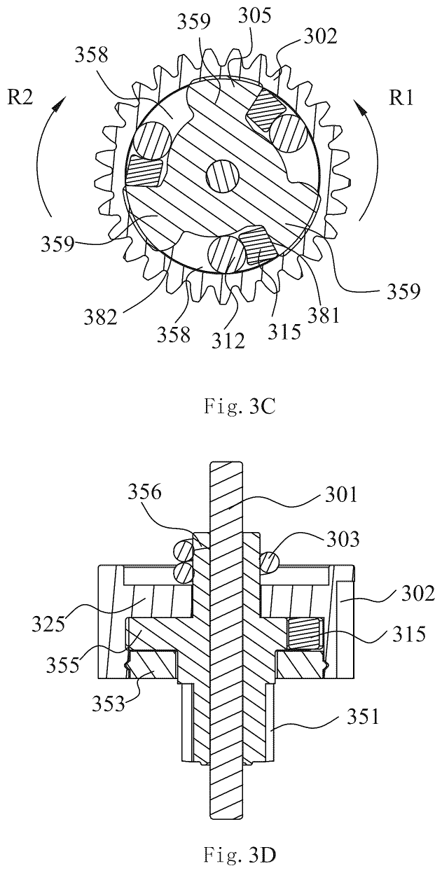

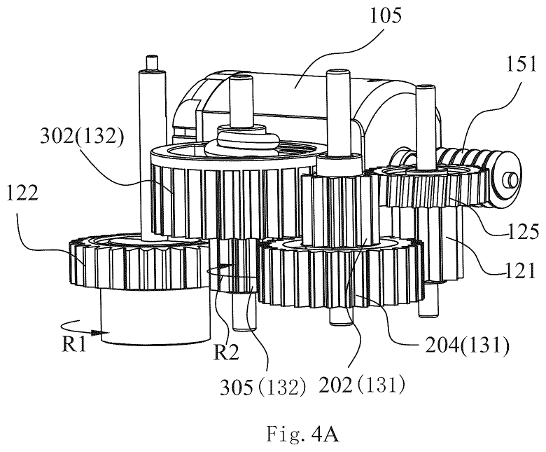

FIG. 3A is a perspective view of the second clutch 132, FIG. 3B is an exploded view of the second clutch 132, FIG. 3C is a radial cross-sectional view of the second clutch 132, and FIG. 3D is an axial cross-sectional view of the second clutch 132. The illustrated second clutch 132 is a composite device that incorporates an overrunning clutch function and a friction clutch function.

As shown in FIGS. 3A-3D, the second clutch 132 includes a second shaft 301, a second driving member 302, a second driven member 305, an overrunning clutch coupling assembly 310 and a friction clutch coupling element 303. The second shaft 301 rotatably connects the second driven member 305 to the housing. The overrunning clutch coupling assembly 310 clamps or releases the second driving member 302 and the second driven member 305 against or from each other, and the friction clutch coupling element 303 connects the second driving member 302 and the second driven member 305 by friction. The overrunning clutch coupling assembly 310 includes three sets of rolling member 312 and elastic member 315.

The second driving member 302 includes an outer ring 323 having meshing teeth on an outer side of the outer ring 323 to mesh with the first driven member 202 of the first clutch 131. The second driving member 302 also includes a support portion 325 provided at an end of the outer ring 323.

The second driven member 305 includes a second driven member meshing portion 351, a support portion 353, a coupling portion 355 and a connecting segment 356 which are axially arranged. The second driven member meshing portion 351 is configured to mesh with the second transmission gear 122. The support portion 353 is configured to limit an axial position of the second driven member 305 relative to the second driving member 302. The coupling portion 355 is accommodated in the second driving member 302, and an outer contour of the coupling portion 355 and an inner contour of the outer ring 323 of the second driving member 302 together define three wedge-shaped spaces 358. Each wedge-shaped space 358 narrows radially in a rotational direction R2 (FIG. 3C). Adjacent wedge-shaped spaces 358 are separated by a partition 359. Each wedge-shaped space 358 has a wider first end wall 381 and a narrower second end wall 382 and accommodates a set of rolling member 312 and elastic member 315. The elastic member 315 is closer to the wider first end wall 381 than the rolling member 312. The connecting segment 356 passes through the support portion 325 of the second driving member 302 and extends out of the second driving member 302.

The friction clutch coupling element 303 is a torsion spring which is sleeved over the connecting segment 356 of the second driven member 305. The torsion spring is fixedly connected to the support portion 325 of the second driving member 302 at one end, and has a free end at the other end. The torsion spring is in an interference fit with the connecting segment 356 of the second driven member 305. Thus, the friction clutch coupling element 303 connects the second driven member 305 with the second driving member 302 by friction.

For the illustrated second clutch 132, if the friction clutch coupling element 303 is not provided, the second driving member 302, the second driven member 305 and the overrunning clutch coupling assembly 310 together form an overrunning clutch, which remains in an engaged state in one rotational direction (i.e., unidirectional engagement) and remains in a disengaged state in the other rotational direction (i.e., unidirectional disengagement). The provision of the friction clutch coupling element 303 changes the unidirectional disengagement behavior of the overrunning clutch, while leaving its unidirectional engagement behavior unchanged. The cooperation of the friction clutch coupling element 303 with the second driving member 302 and the second driven member 305 provides a second torque threshold for the second clutch 132 in the other rotational direction described above, such that in this rotational direction, the engaged and disengaged states of the second clutch 132 are controlled by the friction clutch coupling element 303 based on the magnitude of the torque to be transmitted. The second torque threshold is the maximum torque that the second clutch 132 may transmit in this rotational direction.

As shown in FIG. 3C, in the perspective shown in FIG. 3C, when the second driven member 305 rotates relative to the second driving member 302 in a direction indicated by an arrow R1, the rolling member 312 gradually moves toward the narrower second end wall 382, whereby the rolling member 312 clamps the second driven member 305 and the second driving member 302 against each other, causing them to rotate synchronously to maintain the engaged state. When the rolling member 312 clamps the second driven member 305 and the second driving member 302 against each other, the friction clutch coupling element 303 could not cause relative rotation between the two.

When the second driven member 305 rotates relative to the second driving member 302 in a direction indicated by an arrow R2, the rolling member 312 gradually moves toward the wider first end wall 381, whereby the rolling member 312 gradually releases the second driven member 305 and the second driving member 302 from each other. When the rolling member 312 releases the second driven member 305 and the second driving member 302 from each other, the second driven member 305 and the second driving member 302 are still constrained as the friction clutch coupling element 303 still connects them. However, they can be in the engaged state or disengaged state depending on whether the torque to be transmitted is less than or greater than the second torque threshold. If the torque to be transmitted is less than the second torque threshold, the second driven member 305 and the second driving member 302 do not rotate relative to each other and are thus in the engaged state. If the torque to be transmitted is greater than the second torque threshold, the second driven member 305 and the second driving member 302 rotate relative to each other and are thus in the disengaged state.

In the actuating mechanism of the present disclosure, the second torque threshold is set to be less than the first torque threshold. In some embodiments, the first torque threshold is 6 Nm and the second torque threshold is 1.5-2.5 Nm. As previously mentioned, the first torque threshold is the maximum torque that can be transmitted by the first clutch 131, and the second torque threshold is the maximum torque that can be transmitted by the second clutch 132 in the direction R2 in FIG. 3C.

It will be appreciated by those skilled in the art that in other embodiments, the overrunning clutch coupling assembly 310 may be composed of elements other than those illustrated, and the friction clutch coupling element 303 may also be elements other than those illustrated.

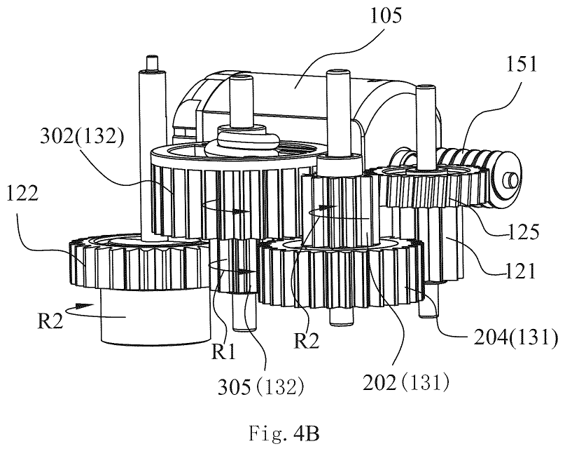

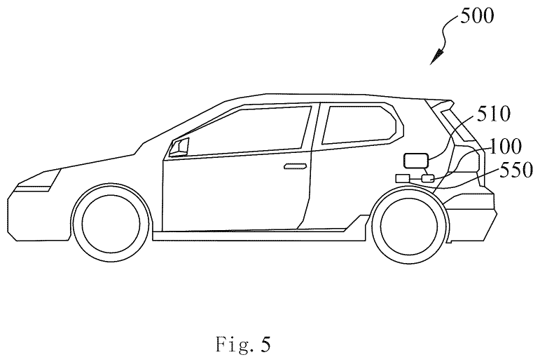

FIGS. 4A and 4B are perspective views of the driving element and the transmission device shown in FIG. 1B in a first operating condition and a second operating condition, respectively, and FIG. 5 is a schematic diagram of a vehicle 500 using the actuating mechanism 100. The arrow R1 indicates a counterclockwise direction (first rotational direction) and the arrow R2 indicates a clockwise direction (second rotational direction). The actuating mechanism 100 is connected to a cover 510 of the fueling port or charging port via the second transmission gear 122. As shown in FIG. 5, the vehicle 500 includes the cover 510 for the fueling port or charging port, and a control device 550 connected to the cover 510. The control device 550 includes, for example, a control circuit provided on the circuit board 104 (FIG. 1B).

As shown in FIGS. 4A and 5, when the cover 510 is subjected to a reverse driving torque in the counterclockwise direction R1, the second transmission gear 122, which is rotationally fixedly connected to the cover 510, is also subjected to a reverse driving torque in the direction R1. The second driven member 305 of the second clutch 132 that meshes with the second transmission gear 122 is thereby subjected to a reverse driving torque in the clockwise direction R2. Since the engaged state or the disengaged state of the second clutch 132 is controlled by the torsion spring when the second driven member 305 of the second clutch 132 is subjected to the reverse driving torque in the direction R2, the holding torque that the actuating mechanism 100 may provide in this scenario is determined by the one of the second clutch 132 and the first clutch 131 of which the maximum transmissible torque (i.e., torque threshold) is smaller (i.e., the second clutch 132). This is because, as the reverse driving torque gradually increases, the second clutch 132 will switch to the disengaged state before the first clutch 131, thereby disconnecting the torque transmission path. Thus, in the operating condition shown in FIG. 4A, the reverse driving torque is transmitted to the second driven member 305 of the second clutch 132 and then stops being transmitted.

As shown in FIGS. 4B and 5, when the cover 510 is subjected to a reverse driving torque in the clockwise direction R2, the second transmission gear 122, which is rotationally fixedly connected to the cover 510, is also subjected to a reverse driving torque in the direction R2. The second driven member 305 of the second clutch 302, which meshes with the second transmission gear 122, is thereby subjected to a reverse driving torque in the counterclockwise direction R1. Since the second clutch 132 remains engaged regardless of the magnitude of the reverse driving torque when the second driven member 305 of the second clutch 302 is subjected to the reverse driving torque in the direction R1, the holding torque of the actuating mechanism 100 is determined by the first torque threshold of the first clutch 131. When the reverse driving torque to be transmitted is greater than the first torque threshold of the first clutch 131, the first clutch 131 switches to the disengaged state, thereby disconnecting the torque transmission path. However, if the reverse driving torque to be transmitted is less than the first torque threshold of the first clutch 131, the first clutch 131 remains in the engaged state.

In one application scenario, when the cover 510 connected to the actuating mechanism 100 is in the open position, an operator may wish to close the cover 510 by applying an external force to the cover 510 in the closing direction, rather than by operating a corresponding button inside the vehicle 500. For example, when the operator performs a charging or refueling operation outside the vehicle 500, and after the operation is completed, the operator wants to close the cover 510 immediately, rather than entering the interior of the vehicle 500 to operate the button. The operating condition shown in FIG. 4A above is particularly suitable for this application scenario.

Specifically, when it is desired to close the cover 510, the operator may push the cover 510 in the open position in the closing direction to apply the cover 510 with the reverse driving torque in the direction R1 as shown in FIG. 4A. When the reverse driving torque to be transmitted exceeds the second torque threshold of the second clutch 132, the second clutch 132 is switched to the disengaged state, and the second driven member 305 rotates in the reverse direction R2 by a certain angle. The sensor 145 can detect the rotation of the second driven member 305 to sense that the second clutch 132 is switched to the disengaged state and to send a sensing signal to the control device 550. Based on the sensing signal received from the sensor 145, the control device 550 may activate the driving element 105 to drive the cover 510 to close. In this application, the operator only needs to apply a short and relatively small external force to the cover 510 to activate the driving element 105 to close the cover 510, so that the closing process of the cover 510 is still performed by the driving element 105, and the operator is not required to enter the vehicle to operate the button for closing the cover 510.

In another application scenario, when the cover 510 is in the closed position, it needs to be stabilized in the closed position to prevent it from being easily opened due to external forces such as vehicle vibrations. The operating condition shown in FIG. 4B above is particularly suitable for this application scenario.

Specifically, when the cover 510 in the closed position is subjected to an external force applying the reverse driving torque in the direction R2 as shown in FIG. 4B, the cover 510 tends to move in the opening direction. However, since the holding torque of the actuating mechanism 100 is determined by the first torque threshold of the first clutch 131 in this case, the holding torque of the actuating mechanism 100 is relatively large. Therefore, if the first clutch 131 needs to be switched to the disengaged state to open the cover 510, a relatively large external force is required. Typically, the external forces such as jolts and vibrations acting on the cover 510 are insufficient to open the cover 510.

Therefore, by incorporating the first clutch and the second clutch, the actuating mechanism of the present disclosure can provide different holding torques in the two rotational directions for the cover, where the holding torque is relatively small in the closing direction of the cover, and the holding torque is relatively large in the opening direction of the cover. As a result, the actuating mechanism of the present disclosure allows the cover in the open position to be easily pushed toward the closed position, and prevents the cover in the closed position from being inadvertently opened due to vibration or other factors.

It will be appreciated by those skilled in the art that in other embodiments of the present disclosure, the positions of the first transmission gear, the second transmission gear, the first clutch and the second clutch in a transmission direction can be arranged as desired, only the relative rotation direction of the second driven member and the second driving member of the second clutch is required to meet the above relationship with the direction of the reverse driving torque. Furthermore, in other embodiments of the present disclosure, the number of transmission gears may be increased or decreased.

Although the present disclosure is described with respect to the examples of embodiments outlined above, various alternatives, modifications, variations, improvements, and/or substantial equivalents that are known or current or to be anticipated before long may be obvious to those of at least ordinary skill in the art. In addition, the technical effects and/or technical problems described in this specification are exemplary rather than limiting; Therefore, the disclosure in this specification may be used to solve other technical problems and have other technical effects and/or may solve other technical problems. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or basic equivalents. MAIN REFERENCE SIGNS
100 Actuating mechanism
101 Housing
102 Top opening
103 Transmission device
104 Circuit board
105 Driving element
107 Bottom opening
108 Cover
109 Housing body
121 First transmission gear
122 Second transmission gear
125 Worm gear
131 First clutch
132 Second clutch
145 Sensor
151 Worm
201 First shaft
202 First driven member
204 First driving member
203 Friction plate
221 First driven member meshing portion
223 Connecting segment
231 Inner surface
232 Outer surface
241 Receiving cavity
301 Second shaft
302 Second driving member
303 Friction clutch coupling element
305 Second driven member
310 Overrunning clutch coupling assembly
312 Rolling member
315 Elastic member
323 Outer ring
325 Support portion
351 Second driven member meshing portion
353 Support portion
355 Coupling portion
356 Connecting segment
358 Wedge-shaped space
359 Partition
381 First end wall
382 Second end wall
500 Vehicle
510 Cover
550 Control device

What is claimed is:

1. An actuating mechanism for driving a driven element to move, comprising:
a driving element providing a positive driving torque; and
a transmission device controllably connecting the driving element and the driven element and comprising a first clutch and a second clutch arranged in series;
wherein the first clutch is designed to be in an engaged state or in a disengaged state depending on whether a torque to be transmitted is less than or greater than a first torque threshold, and the second clutch is designed and arranged such that the second clutch is in an engaged state or a disengaged state depending on whether the torque to be transmitted is less than or greater than a second torque threshold when the driven member is subjected to a reverse driving torque in a first rotational direction, and that the second clutch remains in the engaged state when the driven element is subjected to a reverse driving torque in a second rotational direction; and
wherein the second torque threshold is less than the first torque threshold.

2. The actuating mechanism according to claim 1, wherein
when the driven element is subjected to the reverse driving torque in the first rotational direction, a holding torque provided by the actuating mechanism to the driven element is determined by the second torque threshold, and when the driven element is subjected to the reverse driving torque in the second rotational direction, the holding torque provided by the actuating mechanism to the driven element is determined by the first torque threshold.

3. The actuating mechanism according to claim 2, wherein
the first clutch is a friction clutch; and
the second clutch is a composite device incorporating an overrunning clutch function and a friction clutch function.

4. The actuating mechanism according to claim 2, wherein
the first clutch comprises a first driving member, a first driven member and a friction plate, the friction plate connecting the first driving member and the first driven member by friction to enable the first driving member and the first driven member to rotate relative to each other or not rotate relative to each other depending on the magnitude of the torque to be transmitted, thereby achieving the engaged state or the disengaged state of the first clutch.

5. The actuating mechanism according to claim 2, wherein
the second clutch comprises a second driving member, a second driven member, an overrunning clutch coupling assembly and a friction clutch coupling element, the overrunning clutch coupling assembly is configured to clamp or release the second driving member and the second driven member against or from each other, and the friction clutch coupling element connects the second driving member and the second driven member by friction;
wherein the second clutch is designed such that:
when the second driven member rotates relative to the second driving member in one rotational direction, the overrunning clutch coupling assembly clamps the second driven member and the second driving member against each other, thereby maintaining the second clutch in the engaged state in the one rotational direction; and
when the second driven member rotates relative to the second driving member in the other rotational direction, the overrunning clutch coupling assembly releases the second driven member and the second driving member from each other, the engaged state or the disengaged state of the second driven member and the second driving member is controlled by the friction clutch coupling element, whereby the second driven member and the second driving member are enabled to rotate relative to each other or not rotate relative to each other depending on the magnitude of the torque to be transmitted, achieving the engaged state or the disengaged state of the second clutch in the other rotational direction.

6. The actuating mechanism according to claim 5, wherein
the overrunning clutch coupling assembly comprises a rolling member and an elastic member, and a wedge-shaped space is formed between the second driven member and the second driving member for accommodating the rolling member and the elastic member;
wherein the wedge-shaped space narrows gradually in the radial direction and has a wider first end wall and a narrower second end wall, the elastic member being positioned closer to the first end wall than the rolling member.

7. The actuating mechanism according to claim 6, wherein
the friction clutch coupling element is a torsion spring fixedly connected to the second driving member and is connected to the second driven member via an interference fit.

8. The actuating mechanism according to claim 7, wherein
the second driving member comprises an outer ring and a support portion provided at one end of the outer ring;
wherein the second driven member comprises a coupling portion and a connecting segment arranged axially; and
wherein the coupling portion is accommodated in the outer ring and defines the wedge-shaped space together with the outer ring, the torsion spring is sleeved over the connecting segment, and one end of the torsion spring is connected to the support portion.

9. The actuating mechanism according to claim 3, wherein
the transmission device comprises a worm connected to a shaft of the driving element, and a worm gear meshing with the worm, the worm and the worm gear being configured such that the worm is capable of transmitting the positive driving torque to the worm gear but the worm gear is not capable of transmitting the reverse driving torque to the worm.

10. The actuating mechanism according to claim 9, wherein
the transmission device further comprises a first transmission gear and a second transmission gear, the first transmission gear being rotationally fixedly connected to the worm gear, the second transmission gear being rotationally fixedly connected to the driven element, and the first transmission gear, the first clutch, the second clutch and the second transmission gear meshing in sequence.

11. An actuating mechanism for driving a driven element to move, comprising:
a driving element providing a positive driving torque; and
a transmission device controllably connecting the driving element and the driven element and comprising a first clutch and a second clutch arranged in series;
wherein the first clutch is a friction clutch; and
wherein the second clutch is a composite device incorporating an overrunning clutch function and a friction clutch function.

12. The actuating mechanism according to claim 11, wherein
the second clutch comprises a second driving member, a second driven member, an overrunning clutch coupling assembly and a friction clutch coupling element, the overrunning clutch coupling assembly is configured to clamp or release the second driving member and the second driven member against or from each other, and the friction clutch coupling element connects the second driving member and the second driven member by friction.

13. The actuating mechanism according to claim 12, wherein
the overrunning clutch coupling assembly comprises a rolling member and an elastic member, and a wedge-shaped space is formed between the second driven member and the second driving member for accommodating the rolling member and the elastic member;
wherein the wedge-shaped space narrows gradually in the radial direction and has a wider first end wall and a narrower second end wall, the elastic member being positioned closer to the first end wall than the rolling member.

14. The actuating mechanism according to claim 13, wherein
the friction clutch coupling element is a torsion spring fixedly connected to the second driving member and is connected to the second driven member via an interference fit.

15. The actuating mechanism according to claim 14, wherein
the second driving member comprises an outer ring and a support portion provided at one end of the outer ring;
wherein the second driven member comprises a coupling portion and a connecting segment arranged axially; and
wherein the coupling portion is accommodated in the outer ring and defines the wedge-shaped space together with the outer ring, the torsion spring is sleeved over the connecting segment, and one end of the torsion spring is connected to the support portion.

16. The actuating mechanism according to claim 11, wherein
the transmission device comprises a worm connected to a shaft of the driving element, and a worm gear meshing with the worm, the worm and the worm gear being configured such that the worm is capable of transmitting the positive driving torque to the worm gear but the worm gear is not capable of transmitting the reverse driving torque to the worm.

17. The actuating mechanism according to claim 16, wherein
the transmission device further comprises a first transmission gear and a second transmission gear, the first transmission gear being rotationally fixedly connected to the worm gear, the second transmission gear being rotationally fixedly connected to the driven element, and the first transmission gear, the first clutch, the second clutch and the second transmission gear meshing in sequence.

18. A vehicle, comprising:
an actuating mechanism of claim 1; and
a cover, wherein the cover is the driven element and is used for a fueling port or a charging port of the vehicle, and the cover is configured to move in an opening direction from a closed position to an open position under the action of the positive driving torque provided by the driving element, or to move in a closing direction from the open position to the closed position.

19. The vehicle according to claim 18, further comprising:
a sensor configured to detect that the second clutch is switched to a disengaged state; and
a control device communicatively connected to the sensor;
wherein when the cover in the open position is subjected to the reverse driving torque in the first rotational direction, the cover has a tendency to be closed, the second clutch is switched to the disengaged state when the reverse driving torque in the first rotational direction is greater than the second torque threshold, and the control device controls the driving element to drive the cover to close in response to the second clutch switching to the disengaged state.

20. The vehicle according to claim 18, wherein
when the cover in the closed position is subjected to the reverse driving torque in the second rotational direction, the cover has a tendency to be opened, and the holding torque applied by the actuating mechanism to the cover is determined by the first torque threshold of the first clutch to prevent the cover from being opened with a small force.
